(19) United States
(12) Patent Application Publication
(10) Pub. No.: US 2012/0244436 A1
(43) Pub. Date: Sep. 27, 2012

(54) ANODES OF POROUS SILICON PARTICLES

(75) Inventor: Marie Kerlau, Fremont, CA (US)

(73) Assignee: LEYDEN ENERGY, INC., Fremont, CA (US)

(21) Appl. No.: 13/429,185

(22) Filed: Mar. 23, 2012

Related U.S. Application Data
(60) Provisional application No. 61/467,308, filed on Mar. 24, 2011.
(60) Provisional application No. 61/467,304, filed on Mar. 24, 2011.

(51) Int. Cl. H01M 4/60

(52) U.S. Cl. 429/212; 252/182.1

(57) ABSTRACT

The present invention provides anode materials, methods of producing them, electrochemical cells, and lithium-ion batteries, where the anode material comprises porous silicon and carboxymethyl cellulose. In certain embodiments, the porous silica additionally comprises other materials, such as styrene-butadiene rubber.

This application claims the priority of U.S. Provisional Application Nos. 61/467,304, filed Mar. 24, 2011 and 61/467,308, filed Mar. 24, 2011, both of which are incorporated by reference in their entireties for all purposes.

### BACKGROUND OF THE INVENTION

There is currently great interest in developing a new generation of heat-stable, nonflammable, high-capacity, long-lived, rechargeable batteries for various applications, including the consumer electronics and automobile industries.

Conventional lithium ion batteries commonly use carbon anodes. Ding, N. et al. J. Power Sources 2009, 192, 644. Silicon has over ten times the potential capacity to store electrical charge, making it attractive as a possible alternative anode material. Id. Unlike carbon, however, silicon will expand by up to 300% or more during battery use. See id. Under this mechanical stress, a conventional silicon anode will crack or break apart, reducing the battery's capacity. Id.; Kim, H. et al. Angew. Chem. Int. Ed. 2008, 47, 10151. This disadvantage has been a major technical barrier to the creation of higher capacity anodes from silicon. Id.

Attempts to overcome this problem include the use of alternative binders, alternative electrolytes, and alternative anodes, such as carbon coatings on silicon cores, carbon/silicon mixtures (e.g., a silicon dispersion in a carbon matrix), and silicon nanomaterials. Id.; Baldwin, R. K. et al. Chem. Commun. 2002, 1822; Lestriez, B. et al. Electrochem. Commun. 2007, 9, 2801; Mazouzi, D. et al. Electrochem. Solid-State Lett. 2009, 12, A215. Anodes made from silicon nanomaterials or nanoparticles can incorporate regular pores, allowing a structure's expansion without damage and loss of capacity. Cho, J. J. Mater. Chem. 2010, 20, 4009. However, silicon nanoparticles can aggregate during battery cycling, which impairs battery performance. No general solution has yet been accepted in the field as optimal.

Therefore, there is a need to develop porous-silicon-based lithium-ion electrochemical cells and batteries that have high thermal stability, excellent durability, long cycle life, and high charge density. The present invention satisfies these and other needs.

### BRIEF SUMMARY OF THE INVENTION

In certain embodiments, the invention presents an anode material comprising: porous silicon particles having an average pore diameter of from about 1 nm to about 500 nm; and carboxymethyl cellulose (CMC). Preferably, the porous silicon particle has a particle diameter from about 50 nm to about 250 nm. More preferably, the particle diameter is from about 80 nm to about 150 nm.

In another preferred embodiment, the anode material further comprises styrene-butadiene rubber (SBR).

In certain embodiments, the invention presents a method for preparing an anode material, wherein the method comprises:
contacting a silicon tetrahalide with a reducing agent under conditions sufficient to form a reduced silicon;
contacting the reduced silicon with an alkylating agent or an alkoxide to form an alkyl-capped silicon gel;
drying the alkyl-capped silicon gel;
contacting the dried, alkyl-capped silicon gel with hydrofluoric acid to form porous silicon particles having an average pore diameter from about 1 to about 500 nm; and
mixing the porous silicon particle with carboxymethyl cellulose (CMC), thereby preparing the anode material.

Preferably, the silicon tetrahalide is silicon tetrachloride. Preferably, the reducing agent is sodium naphthalide. Preferably, the alkylating agent is alkyl lithium. In another preferred embodiment, the alkylating agent comprises a C₁₋₆ alkyl group.

In another preferred embodiment, the method further comprises heating the alkyl-capped silicon gel to remove the reducing agent.

In certain embodiments, the invention presents an anode material prepared by a method described herein. In some embodiments, before the porous silicon mixing step with CMC, the method further comprises a step of depositing lithium in a silicon particle pore to form a lithiated mesoporous (i.e., a porous material with an at least partially regular arrangement of pores) or porous silicon particle.

In certain other embodiments, the invention presents a lithium-ion battery (i.e., Li-ion battery) prepared by a method described herein.

These and other aspects, objects, and advantages will become more apparent when read with the following detailed description and drawings.

### DETAILED DESCRIPTION OF THE INVENTION

### I. Definitions

The terms “a,” “an,” or “the” as used herein not only include aspects with one member, but also include aspects with more than one member. For example, an embodiment of a method including the step “contacting a silicon tetrahalide with a reducing agent” should be understood to present certain aspects with two or more silicon tetrahalides, two or more reducing agents, or both.

“About” as used herein applies to a defined range around a numerical value. When “X” is a numerical value, “about X,” generally indicates a value from 0.95X to 1.05X. Any reference to “about X” specifically indicates at least the values X, 0.95X, 0.96X, 0.97X, 0.98X, 0.99X, 1.01X, 1.02X, 1.03X, 1.04X, and 1.05X. Thus, “about X” is intended to imply and provide written description support for a claim limitation of, e.g., “0.98X.” However, when the quantity measured in “X” only includes whole integer values (e.g., “X carbons”), “about X” indicates from (X−1) to (X+1). In this case, “about X” as used herein specifically indicates at least the values X, X−1, and X+1. When “about” is applied to the beginning of a numerical range, it applies to both ends of the range. Thus, “from about 5 to 20%” is equivalent to “from about 5% to about 20%” (and vice versa). When “about” is applied to the first value of a set of values, it applies to all values in that set. Thus, “about 7, 9, or 11%” is equivalent to “about 7%, about 9%, or about 11%.”

The term “alkyl” as used herein, whether by itself or as part of another substituent, includes a straight- or branched-chain hydrocarbon radical having the number of carbon atoms designated (i.e., C₁₋₈ means one to eight carbons). Examples of alkyl groups include methyl, ethyl, n-propyl, isopropyl, n-butyl, t-butyl, isobutyl, sec-butyl, n-pentyl, n-hexyl, n-heptyl, n-octyl, and the like. When a prefix is not included to indicate the number of chain carbon atoms in an alkyl portion, the radical or portion thereof will have 20 or fewer chain carbon atoms.

The term “alkylating agent” as used herein includes a reagent that will forms a bond between an alkyl group and a particular substrate, typically by the nucleophilic displacement of a leaving group. Examples of alkylating agents include alkyl lithiums (e.g., methyl lithium, butyl lithium) or alkyl magnesium reagents (e.g., Grignard reagents). Those of skill in the art will know of other alkylating agents suitable for use in the present invention.

The term “alkoxide” as used herein includes RO⁻, where R is an alkyl group as defined herein. Generally, the anionic alkoxide has an associated cation X, which preferably is a metal ion (e.g., sodium, lithium, or potassium). Examples of alkoxide groups include methoxide, ethoxide, t-butoxide, and the like. Those of skill in the art will know of other alkoxides suitable for use in the present invention.

The terms “halo” or “halogen,” by themselves or as parts of another substituent, includes a fluorine, chlorine, bromine, or iodine atom. “Halide” as used herein refers to the anion of a halogen (e.g., fluoride for fluorine).

The term “ionic liquid” means a salt comprising a cation and an anion. The salt is a liquid at ambient or near ambient temperatures. Preferably, the cations are organic cations.

Generally, when a percentage range is taught, it incorporates all full or partial percentages in between (i.e., within the bounds of the range). For example, a percentage range of 15 to 25% would also teach inter alia the specific values of 17.36% and 21%. A percentage range of about 13 to 17% would also teach inter alia the specific values of 12.97%, 16%, and 17.1%.

The term “negative electrode” as used herein includes one of a pair of rechargeable lithium-ion cell electrodes that under normal circumstances and when the cell is fully charged will have the lowest potential. This terminology is retained to refer to the same physical electrode under all cell operating conditions even if such electrode is temporarily (e.g., due to cell over-discharge) driven to or exhibits a potential above that of the other (the positive) electrode.

The term “or” as used herein should in general be construed non-exclusively. For example, an embodiment of “a battery comprising the anode material A or B” would typically present an aspect with the battery comprising both A and B. “Or” should, however, be construed to exclude those aspects presented that cannot be combined, e.g., without contradiction.

The term “porous” as used herein includes a material with at least one pore (i.e., a hole or opening). In certain embodiments, a pore allows passage of a fluid (e.g., gas- or liquid-phase molecules) through the surface of the material in which the pore is situated. A pore may be, but is not necessarily, linked to a second opening in a material's surface.

The term “positive electrode” as used herein includes one of a pair of rechargeable lithium-ion cell electrodes that under normal circumstances and when the cell is fully charged will have the highest potential. This terminology is retained to refer to the same physical electrode under all cell operating conditions even if such electrode temporarily (e.g., due to cell over-discharge) is driven to or exhibits a potential below that of the other (the negative) electrode.

### II. Anode Material

In certain embodiments, the present invention provides an anode material comprising porous silicon particles having an average pore diameter from about 1 nm to about 500 nm. Preferably, the pore diameter is from about 10 nm to about 400 nm, about 25 nm to about 325 nm, about 50 nm to about 250 nm, or about 60 nm to about 200 nm. Preferably, the porous silicon particle has a pore diameter from about 70 nm to about 175 nm, about 80 nm to about 150 nm, or about 90 nm to about 125 nm. In certain embodiments, the pore diameter is from about 2 nm to about 50 nm, about 2 nm to about 40 nm, about 2 nm to about 25 nm, about 5 nm to about 50 nm, about 5 nm to about 30 nm, about 10 nm to about 50 nm, about 20 nm to about 75 nm, about 25 nm to about 100 nm, about 50 nm to about 150 nm, or about 100 nm to about 200 nm. In certain embodiments, the pore diameter is from about 100 nm to about 250 nm, about 125 nm to about 250 nm, about 150 nm to about 300 nm, about 100 nm to about 400 nm, or about 250 nm to about 500 nm.

In certain embodiments, the present invention provides an anode material comprising porous silicon particles with a particle diameter of from about 50 nm to about 250 nm, about 60 nm to about 200 nm, about 70 nm to about 175 nm, about 80 nm to about 150 nm, or about 90 nm to about 125 nm. In certain embodiments, the particle diameter is from about 25 nm to about 75 nm, about 35 nm to about 100 nm, about 50 nm to about 150 nm, or about 100 nm to about 200 nm. In certain embodiments, the particle diameter is from about 125 nm to about 200 nm, about 125 nm to about 250 nm, about 150 nm to about 300 nm, about 100 nm to about 400 nm, or about 250 nm to about 500 nm. In certain embodiments, the porous silicon particles have an average particle diameter of about 200 nm or less. Without intending to be bound by a particular theory, smaller particle sizes are believed to provide a greater density of silicon, thereby producing better anode properties (e.g., more robust; higher capacity).

In certain embodiments, the present invention provides an anode material comprising carboxymethyl cellulose (CMC). Although not intending to be constrained by theory, the CMC is believed to act as a binder for the silicon particles. In certain embodiments, the binder consists or consists essentially of CMC. In certain other embodiments, the binder further comprises other binding agents, such as styrene-butadiene rubber (SBR), poly(ethylene-co-acrylic acid) (PEAA), poly(vinyl pyrrolidone) (PVP), poly(vinylidene fluoride) (PVDF), other substituted anionic alkyl celluloses, and the like.

Preferably, the binder further comprises SBR. In certain embodiments, the binder further comprises binding agents with low elongation at break, such as polyacrylic acid (PAA) and its salts (e.g., K-, Li- or Na-PAA), polyimide, alginate and the like. Preferably, the binder further comprises PAA or alginate.

In certain embodiments, the present invention provides an anode material substantially free from PVDF. PVDF is used as a binder for both the positive and negative electrodes in commercial lithium-ion batteries. However, current methods for use of PVDF involve toxic, volatile organic compounds (e.g., the VDF monomer). Embodiments of the invention that are substantially free from PVDF present the additional advantage of a more environmentally friendly material. In certain embodiments, “substantially free from PVDF” indicates a detectable level of PVDF or VDF that is at most about 1%, 0.8%, 0.5%, 0.3%, or 0.1%. In certain embodiments, “substantially free” indicates a detectable level of PVDF or VDF that is at most about 0.08%, 0.05%, 0.03%, or 0.01%. In certain embodiments, “substantially free” indicates a detectable level of PVDF or VDF that is at most about 0.008%, 0.005%, 0.003%, or 0.001%. In certain embodiments, “substantially free” indicates a detectable level of PVDF or VDF that is at most about 0.0008%, 0.0005%, 0.0003%, or 0.0001%. In certain preferred embodiments, “substantially free from PVDF” indicates free from detectable PVDF or VDF.

### III. Method of Making

In certain embodiments, the present invention provides a method for making porous silicon particles that comprises contacting a silicon tetrahalide with a reducing agent under conditions sufficient to form a halide-capped silicon. This silicon is then reacted with a capping group, such as an alkylating agent or an alkoxide.

In certain preferred embodiments, the method has further steps. In certain embodiments, to create the three-dimensional porous silicon structure, the resulting silicon material is dried and contacted with a silicon-dissolving reagent such as hydrofluoric acid. Preferably, the pores are created by direct etching with hydrofluoric acid or a solution of hydrofluoric acid.

In certain embodiments, the method comprises contacting a silicon tetrahalide. The silicon tetrahalide can comprise fluoride, chloride, bromide, iodide, or a mixture of halides (e.g., silicon dichloride dibromide). Preferably, the silicon tetrahalide is silicon tetrachloride or tetrabromide. More preferably, the silicon tetrahalide is silicon tetrachloride.

In certain embodiments, the method comprises contacting a reducing agent.

Preferably, the reducing agent is sodium naphthalide. Other reducing agents include alkali and alkali earth metals such as lithium, sodium, potassium, zinc, and the like.

In certain embodiments, the present invention provides a method for making porous silicon particles that comprises contacting the reduced silicon with an alkylating agent or an alkoxide to form a capped silicon gel. Differing capping groups and silicon-dissolving reagents influence the carbon layer's properties. Without intending to be bound by a particular theory, this capping group is believed to create a thin carbon layer that helps to prevent particle aggregation, to prevent silicon dioxide formation, and to stabilize the solid-electrolyte interface (SEI).

In certain embodiments, the method comprises an alkylating agent (i.e., a reactant causing a substrate to form a product with a new bond to an alkyl group). Preferably, the alkylating agent comprises contacting the reduced silicon with a C₁₋₆ alkyl group; more preferably, a C₂₋₃ alkyl group. Preferably, the alkylating agent includes a nucleophilic alkyl group, such as alkyl lithium (e.g., methyl lithium, butyl lithium) or alkyl magnesium reagents (e.g., Grignard reagents). Other possible alkyl group sources include alkyl copper reagents, acetylides, cyanide, and the like.

In certain embodiments, the method comprises an alkoxide. Preferably, the alkoxide comprises contacting the reduced silicon with a C₁₋₆ alkyl group; more preferably, a C₂₋₃ alkyl group. Suitable alkoxides include those derived from the alcohols methanol, ethanol, propanol, isopropanol, butanol, and 2-butanol. Suitable alkoxides can also be derived from diols, such as ethylene glycol and 1,3-propanediol.

In certain embodiments, the method comprises heating the capped silicon to remove the reducing agent or to dry the gel. Preferably, the capped silicon (or, alternatively, the oven interior or other heating vessel containing the capped silicon) is heated to about 100° C., 110° C., 120° C., 130° C., 140° C., 150° C., 175° C., or 200° C. to remove the reducing agent. Preferably, the capped silicon (or, alternatively, the oven interior or other heating vessel containing the capped silicon) is heated to about 40° C., 600° C., 80° C., 100° C., 125° C., 150°C., 175° C., or 200° C. to dry the gel. Preferably, the capped silicon is heated for 1, 2, 4, 8, 14, or 24 hr for drying.

In certain embodiments, the pores are created by direct etching with a silicon-dissolving reagent, such as hydrofluoric acid or a solution of hydrofluoric acid. Pore diameters and pore wall thicknesses are controlled by varying the duration and concentration of the hydrofluoric acid etching. Advantageously, this can minimize contamination of the surface with silicon dioxide, which can decrease battery capacity.

In certain alternative embodiments, the porous silica is created or modified by using templates. In a preferred embodiment, the template is sized to make pores with an average pore diameter within a preferred range as previously described. Preferably, the template comprises silica or alumina. Preferably, the template has an about 20, 40, 50, 60, 70, 80, 90, 100, 125, 150, 175, 200, 250, or 300 nm particle size. Preferably, the resulting silica pores are symmetrical in shape, not irregular. In certain embodiments, the pores may form part of a larger pattern (e.g., domains of a substantially periodic structure similar to a honeycomb).

In a preferred embodiment, the template is removed by etching. Preferably, a chemical etching agent, such as hydrofluoric acid or a solution of hydrofluoric acid, is used for etching. In some embodiments, the concentration of the etching agent is about 0.05, 0.1, 0.2, 0.3, 0.4, 0.5, 0.6, 0.7, 0.8, 0.9, 1.0, 1.1, 1.2, 1.3, 1.4, or 1.5 M. In certain embodiments, the concentration of etching agent used is about 0.5, 0.6, 0.7, 0.8, 0.9, 1.0, 1.1, 1.2, 1.3, 1.4, 1.5, 1.6, 1.7, 1.8, 1.9, or 2.0 M. In certain embodiments, the etching time is about 10 min, 15 min, 20 min, 25 min, 30 min, 40 min, 45 min, 50 min, 1.0 hour, 1.1 hour, 1.25 hours, 1.5 house, 1.75 hours, 2 hours, 2.25 hours, 2.5 hours, 2.75 hours, 3.0 hours, 3.25 hours, 3.5 hours, 3.75 hours, 4.0 hours, 4.25 hours, 4.5 hours, 4.75 hours, or 5 hours.

In a preferred embodiment, the CMC is added to the porous silica in a slurry. Preferably, the slurry comprises water. Preferably, the slurry's pH is modified to increase the contact between the CMC and the porous silicon; more preferably, the slurry's pH is acidic and adjusted to about 3.5.

In certain embodiments, the present invention provides a method for making porous silicon particles that further comprising depositing a metal (e.g., an alkali metal, such as lithium) into the pore before the mixing step to form a metal-containing (e.g., lithiated) porous silicon particle. Preferably, the metal is deposited by a method of chemical vapor deposition.

In certain embodiments, the porous silicon particles (or, alternatively, the oven interior or other heating vessel containing the capped silicon) is heated to about 500° C., 600° C., 700° C., 800° C., 850° C., 900° C., 950° C., 1000° C., 1100° C., or 1200° C. to anneal the gel.

### IV. Lithium Ion Batteries

In one aspect, the present invention sets forth an electrochemical cell that includes (i) a positive electrode comprising a positive electrode material and a positive electrode current collector; wherein the positive electrode material is in electronically conductive contact with the positive electrode current collector; (ii) a negative electrode comprising a negative electrode material and a negative electrode current collector; wherein the negative electrode material is in electronically conductive contact with the negative electrode current collector; and (iii) an ion conductive medium comprising an ion conductive layer and an electrolyte solution in ionically conductive contact with the positive electrode and the negative electrode. See, e.g., US 2010/0285352 A1; PCT/US2009/045723; WO 2009/148971; U.S. patent application Ser. No. 12/953,335.

Preferably, the electrochemical cell further comprises at least one positive electrode tab having a first attachment end and a second attachment end, wherein the first attachment end is connected to the positive electrode current collector. Preferably, the positive electrode comprises LiCoO₂, LiNi/Co/AlO₂, LiFePO₄, or LiNi/Co/MnO₂ mixed oxides. In some embodiments, the positive electrode comprises LiMn₂O₄ or high-voltage spinel. Preferably, the positive electrode current collector is a conductive sheet selected from the group consisting of a sheet, a fiber sheet, a foam, a nanotube film, a nanofilm, and a mixture thereof, each of which has an in-plane electrical conductivity of at least about 1000 S/cm. More preferably, the in-plane electrical conductivity is at least about 1100 S/cm, 1200 S/cm, 1300 S/cm, 1400 S/cm, 1500 S/cm, 1750 S/cm, or 2000 S/cm.

Preferably, the electrochemical cell further comprises at least one negative electrode tab having a first attachment end and a second attachment end, wherein the first attachment end is connected to the negative electrode current collector; and wherein the tabs are made from an electrically conductive material, such as a metal, a metal alloy or a composite material. In one embodiment, the metal is selected from the group consisting of copper, nickel, chromium, aluminum, titanium, stainless steel, gold, tantalum, niobium, hafnium, zirconium, vanadium, indium, cobalt, tungsten, beryllium and molybdenum and alloys thereof or an alloy thereof.

In certain instances, the tab has protective coatings against corrosion. The coatings can be any of the above metals, anodizing and oxide coatings, conductive carbon, epoxy and glues, paints and other protective coatings. In other instances, the coatings can be nickel, silver, gold, palladium, platinum, rhodium or combinations thereof for improving conductivity of the tabs. The alloys can be a combination of metals described herein or formed by combining the metals described above with other suitable metals known to persons of skill in the art.

In certain instances, the electrolyte solution comprises LiPF₆.

In certain instances, the electrolyte solution comprises a lithium compound and a solvent selected from an ionic liquid of formula (I) or a mixture of an organic solvent and an ionic liquid of formula (I):

Q⁺E⁻ (I)

Q⁺ is a cation selected from the group consisting of dialkylammonium, trialkylammonium, tetraalkylammonium, dialkylphosphonium, trialkylphosphonium, tetraalkylphosphonium, trialkylsulfonium, (R^{f})₄N⁺ and an N-alkyl or N-hydrogen cation of a 5- or 6-membered heterocycloalkyl or heteroaryl ring having from 1-3 heteroatoms as ring members selected from N, O or S, wherein the heterocycloalkyl or heteroaryl ring is optionally substituted with from 1-5 optionally substituted alkyls and R^{f} is alkyl or alkoxyalkyl. E is an anion selected from the group consisting of R¹—X⁻R²(R³)ₘ, NC—S⁻, BF₄⁻, PF₆⁻, R^{a}SO₃⁻, R^{a}P⁻F₃, R^{a}CO₂⁻, I⁻, ClO₄⁻, (FSO₂)₂N—, AsF₆⁻, SO₄⁻, B⁻(OR^{d})₂(OR^{e})₂ and bis[oxalate(2-)—O,O′]borate. The subscript m is 0 or 1. Xis N when m is 0. X is C when m is 1. R¹, R² and R³ are each independently an electron-withdrawing group selected from the group consisting of halogen, —CN, —SO₂R^{b}, —SO₂—L^{a}—SO₂N⁻Li⁺SO₂R^{b}, —P(O)(OR^{b})₂, —P(O)(R^{b})₂, —CO₂R^{b}, —C(O)R^{b} and —H, with the proviso that R¹ and R² are other than hydrogen when m=0, and no more than one of R¹, R² and R³ is hydrogen when m=1. Each R^{a} is independently C₁₋₈ perfluoroalkyl. L^{a} is C₁₋₄ perfluoroalkylene. Each R^{b} is independently selected from the group consisting of C₁₋₈ alkyl, C₁₋₈ haloalkyl, C₁₋₈ perfluoroalkyl, perfluorophenyl, aryl, optionally substituted barbituric acid and optionally substituted thiobarbituric acid. At least one carbon-carbon bond of the alkyl or perfluoroalkyl are optionally substituted with a member selected from —O— or —S— to form an ether or a thioether linkage and the aryl is optionally substituted with from 1-5 members selected from the group consisting of halogen, C₁₋₄haloalkyl, C₁₋₄perfluoroalkyl, —CN, —SO₂R^{c}, —P(O)(OR^{c})₂, —P(O)(R^{c})₂, —CO₂R^{c} and —C(O)R^{c}, wherein R^{c} is independently C₁₋₈ alkyl, C₁₋₈ perfluoroalkyl or perfluorophenyl and L^{a} is C₁₋₄perfluoroalkylene. R^{d} and R^{e} are each independently an alkyl group In one embodiment, two R^{d} groups together with the oxygen atoms to which the two R^{d} groups are attached and the boron atom to which the oxygen atoms are attached form a five- or six-member ring, which is optionally fused with a six-membered aromatic ring having 0-1 nitrogen heteroatom, and optionally two R^{e} groups together with the oxygen atoms to which the two R^{d} groups are attached and the boron atom to which the oxygen atoms are attached form a five- or six-member ring, which is optionally fused with a six-membered aromatic ring having 0-1 nitrogen heteroatom. In some embodiments, at least one positive electrode tab having a first attachment end and a second attachment end, wherein the first attachment end is connected to the positive electrode current collector; optionally, at least one negative electrode tab having a first attachment end and a second attachment end, wherein the first attachment end is connected to the negative electrode current collector.

In another aspect, the present invention provides a battery. The battery includes a housing, a positive connector, a negative connector, a electrochemical cell disposed in the housing, where the positive and the negative connector are mounted on the housing. In one embodiment, the housing is a sealed container.

In another aspect, the present invention provides a battery pack. The battery pack includes a plurality of cells, wherein each cell comprises an ionic liquid of formula (I):

Q⁺E⁻ (I)

wherein Q⁺ is a cation selected from the group consisting of dialkylammonium, trialkylammonium, tetraalkylammonium, dialkylphosphonium, trialkylphosphonium, tetraalkylphosphonium, trialkylsulfonium, (R^{f})₄N⁺ and an N-alkyl or N-hydrogen cation of a 5- or 6-membered heterocycloalkyl or heteroaryl ring having from 1-3 heteroatoms as ring members selected from N, O or S, wherein the heterocycloalkyl or heteroaryl ring is optionally substituted with from 1-5 optionally substituted alkyls and each R^{f} is independently alkyl or alkoxyalkyl. E⁻ is an anion selected from the group consisting of R¹—X⁻R²(R³)ₘ, NC—S⁻, BF₄⁻, PF₆⁻, R^{a}SO₃⁻, R^{a}P⁻F₃, R^{a}CO₂⁻, I⁻, ClO₄⁻, (FSO₂)₂N—, AsF₆⁻, SO₄^{—} and bis[oxalate(2-)O,O′]borate, wherein m is 0 or 1. X is N when m is 0. X is C when m is 1. R¹, R² and R³ are each independently an electron-withdrawing group selected from the group consisting of halogen, —CN, —SO₂R^{b}, —SO₂—L^{a}—SO₂N⁻Li⁺SO₂R^{b}, —P(O)(OR^{b})₂, —P(O)(R^{b})₂, —CO₂R^{b}, —C(O)R^{b} and —H; with the proviso that R¹ and R² are other than hydrogen when m=0, and no more than one of R¹, R² and R³ is hydrogen when m=1. Each R^{a} is independently C₁₋₈ perfluoroalkyl. Each R^{b} is independently selected from the group consisting of C₁₋₈ alkyl, C₁₋₈ haloalkyl, C₁₋₈ perfluoroalkyl, perfluorophenyl, aryl, optionally substituted barbituric acid, and optionally substituted thiobarbituric acid. At least one carbon-carbon bond of the alkyl or perfluoroalkyl are optionally substituted with a member selected from —O— or —S— to form an ether or a thioether linkage and the aryl is optionally substituted with from 1-5 members selected from the group consisting of halogen, C₁₋₄haloalkyl, C₁₋₄perfluoroalkyl, —CN, —SO₂R^{c}, —P(O)(OR^{c})₂, —P(O)(R^{c})₂, —CO₂R^{c} and —C(O)R^{c}, wherein R^{c} is independently C₁₋₈ alkyl, C₁₋₈ perfluoroalkyl or perfluorophenyl and L^{a} is C₁₋₄perfluoroalkylene.

As background, this patent incorporates by reference the teachings of U.S. Pat. Nos. 4,830,940; 5,472,808; 5,529,859; 5,571,635; 5,639,577; 6,019,802; 6,203,947; 6,261,722; 6,679,846; 6,506,524; 6,699,623; 6,780,541; and 6,790,243.

### EXAMPLES

### Example 1

### Synthesis of Porous Silicon

The first steps are conducted in a glove box under an argon atmosphere. Sodium naphthalide solution is prepared by mixing sodium metal with naphthalene in 1,2-dimethoxyethane (DME) solvent for two hours. A solution of silicon tetrachloride in DME is added, and the combination is mixed overnight. Alkyl lithium (e.g., methyl lithium) is then added to the solution and mixed overnight to terminate the silicon atoms by an alkyl group.

The solution is taken out of the glove box to retrieve the alkyl-capped silicon gel. The DME is removed by evaporation using a rotary evaporator. The resulting gel is then heated at 130° C. in a vacuum oven (i.e., the oven temperature was 130° C.) for 8 h to remove naphthalene. The resulting powder is extracted with hexane, and the organic phase is washed six times with water in an extraction funnel to remove sodium and lithium chloride. The powder is then dried at 100° C. in a vacuum oven (i.e., the oven temperature was 200° C.) for at least six hours.

The dried, alkyl-capped silicon is then mixed with a dilute hydrofluoric acid solution to form pores on the surface of the silicon. Depending on the pore characteristics required, the concentration of hydrofluoric acid used is from 0.5 to 2 M, and the etching time is from 30 min to 5 hours. The mixture is filtered. After the solids are washed with water and alcohol, the silicon product is dried under vacuum at 100° C. for six hours.

### Example 2

### Synthesis of Porous Silicon II

The first steps are conducted in a glove box under an argon atmosphere. Sodium naphthalide solution is prepared by mixing sodium metal with naphthalene in 1,2-dimethoxyethane (DME) solvent for two hours. A solution of silicon tetrachloride in DME is added, and the combination is poured into a Hastelloy Parr reactor. A vacuum is applied to the reactor so that the pressure is between 150 mTorr and 1 Torr. The temperature of the reactor is adjusted between 200° C. and 400° C. The reaction time varies between 2 hours to 24 hours. After the reaction, the reactor is opened, and alkyl lithium (e.g., methyl lithium) is then added to the solution and mixed overnight to terminate the silicon atoms by an alkyl group.

The solution is taken out of the glove box to retrieve the alkyl-capped silicon gel. The DME is removed by evaporation using a rotary evaporator. The resulting gel is then heated at 130° C. in a vacuum oven (i.e., the oven temperature was 130° C.) for 8 h to remove naphthalene. The resulting powder is extracted with hexane, and the organic phase is washed six times with water in an extraction funnel to remove sodium and lithium chloride.

The dried, alkyl-capped silicon is then mixed with a dilute hydrofluoric acid solution to form pores on the surface of the silicon. Depending on the pore characteristics required, the concentration of hydrofluoric acid used is from 0.5 to 2 M, and the etching time is from 30 min to 5 hours. The mixture is filtered. After the solids are washed with water and alcohol, the silicon product is dried under vacuum at 100° C. for six hours.

Optionally, the alkyl capped silicon is then annealed at 900° C. under argon for three hours. The annealed products are washed with water and alcohol, and the silicon product is dried under vacuum at 100° C. for six hours.

All publications and patent applications cited in this specification are herein incorporated by reference as if each individual publication or patent application were specifically and individually incorporated by reference. This includes the two priority applications that are identified by attorney docket numbers 026951-001600US (entitled “Anodes with Mesoporous Silicon Particles.”) and 026951-001700US (entitled “Anodes of Porous Silicon Particles”). It also includes the co-filed U.S. application that is identified by attorney docket numbers 91328-834245-001610US (entitled “Anodes with Mesoporous Silicon Particles.”) and the international application that is identified by 91328-834246-001610PC (entitled “Anodes of Mesoporous or Porous Silicon Particles”).

Although sample embodiments of the foregoing invention have been described in some detail, it will be readily apparent to those of ordinary skill in the art that in light of the teachings of this invention, certain changes and modifications may be made thereto without departing from the spirit or scope of the appended claims.

What is claimed is:

1. An anode material comprising:
porous silicon particles having an average pore diameter of from about 1 to about 500 nm; and
carboxymethyl cellulose (CMC).

2. The anode material of claim 1, wherein the porous silicon particle has a particle diameter from about 50 to about 250 nm.

3. The anode material of claim 1, wherein the porous silicon particle has a particle diameter from about 80 to about 150 nm.

4. The anode material of claim 1, further comprising styrene-butadiene rubber (SBR).

5. A method for preparing the anode material of claim 1, comprising:
contacting a silicon tetrahalide with a reducing agent under conditions sufficient to form a reduced silicon;
contacting the reduced silicon with an alkylating agent or an alkoxide to form an alkyl-capped silicon gel;
drying the alkyl-capped silicon gel;
contacting the dried, alkyl-capped silicon gel with hydrofluoric acid to form porous silicon particles having an average pore diameter from about 1 to about 500 nm; and
mixing the porous silicon particle with carboxymethyl cellulose (CMC), thereby preparing the anode material of claim 1.

6. The method of claim 5, wherein the silicon tetrahalide is silicon tetrachloride.

7. The method of claim 5, wherein the reducing agent is sodium naphthalide.

8. The method of claim 5, wherein the alkylating agent is alkyl lithium.

9. The method of claim 5, wherein the alkylating agent comprises a C₁₋₆ alkyl.

10. The method of claim 5, further comprising heating the alkyl-capped silicon gel to remove the reducing agent.

11. An anode material prepared by the method of claim 5.

12. A Li-ion battery comprising the anode material of claim 1.

13. Use of porous silicon particles and carboxymethyl cellulose for an anode material, wherein the silicon particles have an average pore diameter from about 1 nm to about 500 nm.
